(19) United States
(12) Patent Application Publication
(10) Pub. No.: US 2006/0034156 A1
(43) Pub. Date: Feb. 16, 2006

(54) Method for tracking use of electronic apparatus

(75) Inventor: Jiun-Shiung Chen, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/200,732

(22) Filed: Aug. 10, 2005

(30) Foreign Application Priority Data
Aug. 11, 2004 (TW) 093124114

(51) Int. Cl. G04B 47/00

(52) U.S. Cl. 368/10

(57) ABSTRACT

In a method for tracking user's habits of using an electronic apparatus, a counting table is built in the electronic apparatus. The counting table is updated whenever a specified one of the actuation keys is manipulated. The updated information of the counting table is then transmitted to an information center. According to the updated information of the counting table, user's habits of using the electronic apparatus can be analyzed.

### FIELD OF THE INVENTION

The present invention relates to a method for tracking a user's behavior, and more particularly to a method for tracking a user's habits of using an electronic apparatus.

### BACKGROUND OF THE INVENTION

For facilitating successful commercialization of electronic apparatuses, it is important for the electronic apparatus to be as user-friendly as possible. Take the input interface of an electronic apparatus for example. It would be better if the control and input buttons arranged on the input interface are determined according to users' preferences. With increasing functions of electronic apparatuses, the arrangement of the control and input buttons is getting more and more crucial.

As shown in FIG. 1, the input interface of a DVD player 90 typically includes several buttons 91 on the front panel 901 and a corresponding remote controller 92, respectively. In order to well distribute these buttons within the limited space, many investigations were made to realize users' in input and control. Conventionally, the investigations are performed through questionnaires or market surveys. Since these kinds of investigations are obtained according to rough impressions of the users, the results should not be very reliable. In addition, the valid samples are not sufficient enough for the analysis of common users' behaviors.

### SUMMARY OF THE INVENTION

Therefore, the present invention provides a method for readily and reliably tracking users' habits of using an electronic apparatus.

The present invention provides a method for tracking user's habits of using an electronic apparatus, wherein the electronic apparatus has a plurality of actuation keys. The method comprises steps of building a counting table; updating the counting table whenever a specified one of the actuation keys is manipulated; transmitting updated information of the counting table to an information center; and tracking user's habits of using the electronic apparatus according to the updated information of the counting table.

In an embodiment, the updated information of the counting table is built in the electronic apparatus and automatically transmitted to the information center via Internet while the electronic apparatus is linking to the information center.

In an embodiment, the updated information of the counting table is built in the electronic apparatus and manually transmitted to the information center by the user via Internet while the electronic apparatus is linking to the information center.

In an embodiment, the electronic apparatus enters an information-revealing mode to allow the user to access to the updated information of the counting table, and the updated information of the counting table is then manually transmitted to the information center by the user via a questionnaire.

In an embodiment, the method further comprises steps of updating the counting table whenever another specified one of the actuation keys is manipulated and/or updating the counting table whenever a specified command is generated. The specified command can be the one generated in response to the manipulation of either of the specified actuation keys.

In an embodiment, the counting table is stored in a non-volatile memory of the electronic apparatus.

In an embodiment, the updated information of the counting table includes a series of representative symbols. One of the representative symbols is used for indicating a count of occurrence of the specified actuation key.

For example, the representative symbols are selected from a group consisting of Arabic numbers and alphabetic letters which represent different counts of occurrence.

The present invention provides another method for tracking user's habits of using an electronic apparatus, wherein the electronic apparatus comprising a plurality of actuation keys and a counting table. The method comprises steps of: updating the counting table whenever a specified one of the actuation keys is manipulated; entering the electronic apparatus into an information-revealing mode to realize information of the counting table in response to a user's operation; transmitting the information of the counting table to an information center; and tracking user's habits of using the electronic apparatus according to the information of the counting table.

The present invention provides another method for tracking user's habits of using an electronic apparatus, wherein the electronic apparatus comprising a plurality of actuation keys and a counting table. The method comprises steps of: updating a first part of the counting table whenever a specified command is generated; transmitting updated information of the counting table to an information center; and tracking user's habits of using the electronic apparatus according to the updated information of the counting table.

In an embodiment, the method further comprises steps of updating a second part of the counting table whenever a first specified one of the actuation keys is manipulated to generate the specified command, and updating a third part of the counting table whenever a second specified one of the actuation keys is alternatively manipulated to generate the specified command.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram illustrating an input interface of a DVD player;

FIG. 2 is a schematic circuit block diagram of a DVD player;

FIG. 3(a) is a schematic diagram illustrating a mapping table where the relationship between representative symbols and counts of occurrences of push buttons/commands are shown according to an example of the present invention; and

FIG. 3(b) is a schematic diagram illustrating a conversion table where counts of occurrences of push buttons/commands are shown as representative symbols according to the exemplified mapping table of FIG. 3(a).

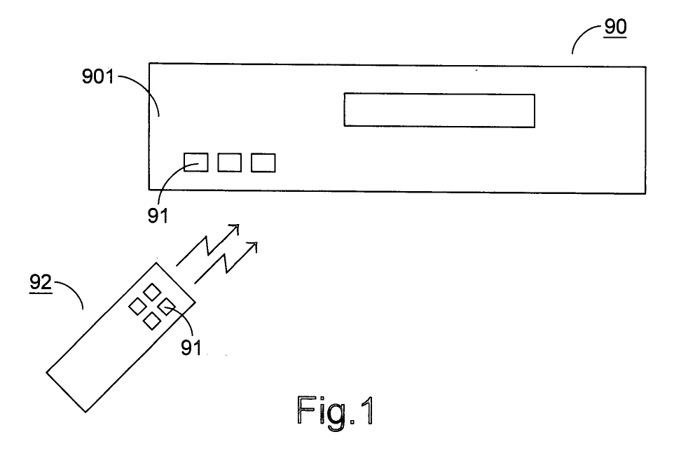

### DETAILED DESCRIPTION OF THE PREFERRED EMBODIMENT

In order to readily and reliably tracking users' habits of using an electronic apparatus, the present invention incorporates a recording mechanism into the electronic apparatus to record practical using situation of the users. Once the recorded data is available, users' habits of using the electronic apparatus can be realized by analyzing these data. The present invention will be described hereinafter by taking a DVD player as an example of the electronic apparatus.

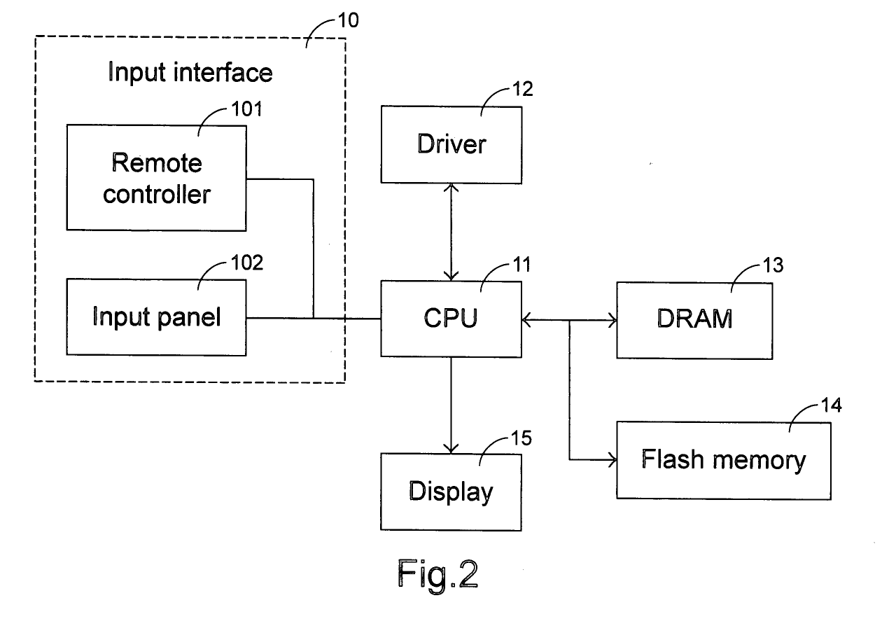

Referring to FIG. 2, a schematic circuit block diagram of a DVD player is shown. The DVD player is used with a display 15 and includes an input interface 10, a central processing unit (CPU) 11, a driver 12, a dynamic random access memory (DRAM) 13 and a flash memory 14. The input interface 10 is used for inputting commands to the CPU and can be any suitable type of input device with actuation keys arranged thereon. For example, the input interface can be a remote controller 101 and/or control panel 102 with push buttons. The CPU executes these commands and controls peripheral devices to perform corresponding functions. One of the functions is to record the using situation of the users. The CPU builds a counting table in the flash memory 14. Whenever the buttons on the remote controller 101 and/or control panel 102 are actuated under normal operation mode, the CPU 11 updates the counting table accordingly. For example, in the counting table, the pushed occurrence of each button or key and the executed occurrence of each command are recorded. According to the counting table, much information can be realized for modifying the design of the input interface, e.g. the arrangement of the buttons or keys, subsequently.

As mentioned above, the practical using data are recorded in the flash memory of the DVD player. Therefore, it is necessary for the manufacturer or designer of the DVD player to acquire the recorded data. According to the present invention, these data can be accessed to in many ways. For example, the recorded data can be acquired via Internet when the DVD player is linked to the website of the manufacturer or designer to update firmware or perform any other data transmission. The counting table stored in the flash memory can be transmitted to an information center set up in the website via Internet automatically or manually.

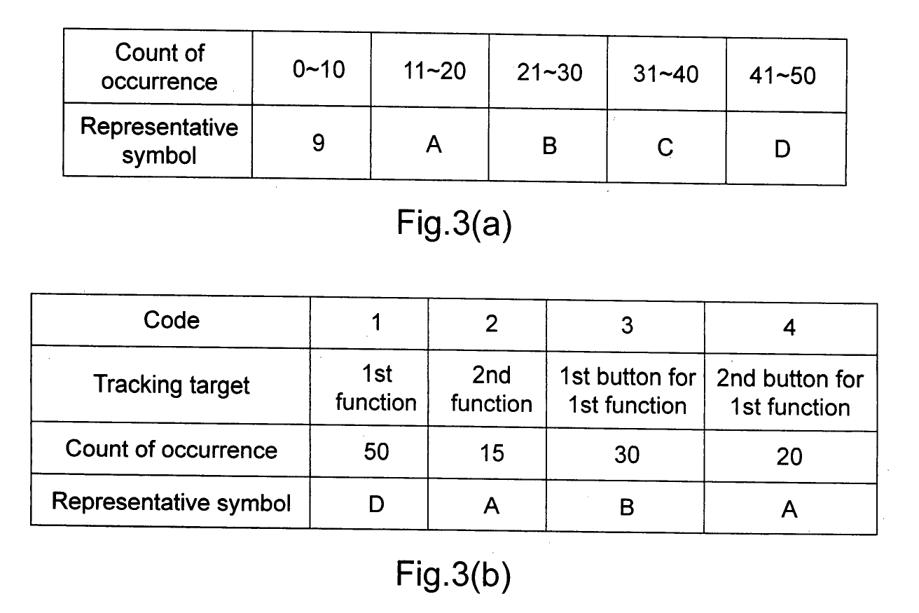

Since some users never link their DVD players to the Internet, alternative methods would be required to access to the data stored in the flash memory of the DVD player. For example, the manufacturer or designer can directly ask the users for the data via telephones, emails, postcards or any other format of questionnaires. However, it is impossible for the users to “read” and “convey” the counting table from the flash memory to the manufacturer or designer. Therefore, it is preferred that the counting table can be stored in or transformed into a readable pattern. One of the examples is illustrated in FIGS. 3(a) and 3(b). In order to reduce data size, the readable pattern is advantageously expressed with a hybrid combination. For example, an Arabic number 9 is used to represent a count ranged between 0 and 10, an alphabetic letter A is used to represent a count ranged between 11 and 20, an alphabetic letter B is used to represent a count ranged between 21 and 30, an alphabetic letter C is used to represent a count ranged between 31 and 40, and an alphabetic letter D is used to represent a count ranged between 41 and 50, as exemplified in a mapping table of FIG. 3(a). In a case that two new functions are to be investigated, wherein the first function can be performed with the actuation of either of two selected buttons and the second function can be performed with the actuation of the only button, a conversion table as exemplified in FIG. 3 (b) is built according to the mapping table of FIG. 3(a). In the conversion table, the using situation of the pushed counts of these three buttons and the executed counts of these two functions are expressed with codes 1˜4, wherein code 1 is used to represent the occurrence of the first function, code 2 is used to represent the occurrence of the second function, code 3 is used to represent the occurrence of the first button for entering the first function, and code 4 is used to represent the occurrence of the second button for entering the first function. Since the third button for entering the second function is the only one, the code for representing the pushed occurrence of the third button can be optionally omitted because it will be identical to the code 2.

In the embodiment of FIG. 3(b), the first function is performed 50 times totally, 30 times of which are performed through the first button and the rest 20 times are performed through the second button. On the other hand, the second function is performed 15 times through the third button. Accordingly, codes 1˜4 are recorded as D, A, B and A, respectively. Since the counting table has been simplified as “DABA”, it becomes easy to be conveyed by the user. The user can realize this information by entering the DVD player into a specified information-revealing mode. For example, the counting table information can be displayed under the product information display mode or any other suitable video or audio mode. Via telephone, email, postcard, etc., the information center can be informed of the counting table information, and decode the counting table information to realize the counts of occurrence of the buttons and commands.

The above embodiment of the invention is exemplified with a DVD player. Nevertheless, the present method can be applied to any other electronic apparatus that needs to be modified according to users' behaviors or habits. Examples are mobile phones, personal digital assistants (PDAs), home appliances and so on. The storage device for recording therein the counting table can be any suitable type of storage device, e.g. another type of nonvolatile memory in addition to the flash memory. From the above description, it is understood that a readily and reliably tracking method is now available according to the present invention to realize users' habits of using an electronic apparatus. Therefore, the electronic apparatus can be improved according to the reliable information from the users' ends so as to facilitate successful commercialization of the products.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for tracking user's habits of using an electronic apparatus, said electronic apparatus comprising a plurality of actuation keys, said method comprising steps of:
building a counting table;
updating said counting table whenever a specified one of the actuation keys is manipulated;
transmitting updated information of said counting table to an information center; and
tracking user's habits of using the electronic apparatus according to said updated information of said counting table.

2. The method according to claim 1 wherein said updated information of said counting table is built in the electronic apparatus and automatically transmitted to said information center via Internet while the electronic apparatus is linking to said information center.

3. The method according to claim 1 wherein said updated information of said counting table is built in the electronic apparatus and manually transmitted to said information center by the user via Internet while the electronic apparatus is linking to said information center.

4. The method according to claim 1 wherein said updated information of said counting table is manually transmitted to said information center by the user via a questionnaire.

5. The method according to claim 4 wherein the electronic apparatus enters an information-revealing mode to allow the user to access to said updated information of said counting table and convey said updated information of said counting table to said information center.

6. The method according to claim 1 further comprising a step of updating said counting table whenever another specified one of the actuation keys is manipulated.

7. The method according to claim 1 further comprising a step of updating said counting table whenever a specified command is generated.

8. The method according to claim 7 wherein said specified command is generated in response to the manipulation of said specified actuation key.

9. The method according to claim 1 wherein said counting table is stored in a non-volatile memory of the electronic apparatus.

10. The method according to claim 1 wherein said updated information of said counting table includes a series of representative symbols.

11. The method according to claim 10 wherein one of said representative symbols is used for indicating a count of occurrence of said specified actuation key.

12. The method according to claim 10 wherein said representative symbols are selected from a group consisting of Arabic numbers and alphabetic letters which represent different counts of occurrence.

13. A method for tracking user's habits of using an electronic apparatus, said electronic apparatus comprising a plurality of actuation keys and a counting table, said method comprising steps of:
updating the counting table whenever a specified one of the actuation keys is manipulated;
entering the electronic apparatus into an information-revealing mode to realize information of said counting table in response to a user's operation;
transmitting said information of said counting table to an information center; and
tracking user's habits of using the electronic apparatus according to said information of said counting table.

14. The method according to claim 13 wherein said information of said counting table includes a series of representative symbols, and one of said representative symbols corresponds to a count of occurrence of said specified actuation key.

15. The method according to claim 13 wherein said information of said counting table is automatically transmitted to said information center via Internet while the electronic apparatus is linking to said information center.

16. The method according to claim 13 wherein said information of said counting table is manually transmitted to said information center by the user via Internet while the electronic apparatus is linking to said information center.

17. The method according to claim 13 wherein said information of said counting table is manually transmitted to said information center by the user via a questionnaire.

18. A method for tracking user's habits of using an electronic apparatus, said electronic apparatus comprising a plurality of actuation keys and a counting table, said method comprising steps of:
updating a first part of said counting table whenever a specified command is generated;
transmitting updated information of said counting table to an information center; and
tracking user's habits of using the electronic apparatus according to said updated information of said counting table.

19. The method according to claim 18 further comprising steps of updating a second part of said counting table whenever a first specified one of the actuation keys is manipulated to generate said specified command, and updating a third part of said counting table whenever a second specified one of the actuation keys is alternatively manipulated to generate said specified command.

20. The method according to claim 19 wherein said updated information of said counting table includes a series of representative symbols, three of which represent counts of occurrences of said specified command, said first specified actuation key and said second specified actuation key.
